(19) United States
(12) Patent Application Publication
(10) Pub. No.: US 2017/0041031 A1
(43) Pub. Date: Feb. 9, 2017

(54) SEMI-CLOSE LOOP DC OFFSET COMPENSATION TECHNIQUE

(71) Applicant: GainSpan Corporation, San Jose, CA (US)

(72) Inventor: Ravi Kumar Vaishnav, Santa Clara, CA (US)

(21) Appl. No.: 14/816,433

(22) Filed: Aug. 3, 2015

(51) Int. Cl. H04B 1/10; H04B 17/21

(52) U.S. Cl. CPC H04B 1/1027; H04B 17/21

(57) ABSTRACT

Systems and methods for calibrating DC offset of wireless device are disclosed. The calibration process includes determining the DC offset based on the step size determined for each particular wireless chipset or wireless device, which may be determined in the factory or in the field. The DAC compensation corresponding to the DC offset may then be applied to the baseband of the receive chain of the chipset.

### BACKGROUND

1. Field

The present disclosure relates generally to wireless devices, and, more specifically, to systems and methods for a semi-close loop DC offset compensation technique.

2. Related Art

A wireless network generally includes two or more wireless devices that communicate with each other over a wireless medium. One example of a wireless network is a wireless local area network (WLAN) designed to operate according to IEEE 802.11 standards.

DC offset is usually undesirable because it causes saturation or change in the operating point of an amplifier in the wireless device. When a receiver (or wireless chipset) is integrated in a final product and connected to an antenna, it is exposed to all kind of interferences from other transmitters, microwave ovens, other appliances, and the like. DC Offset is particularly sensitive to input impedance. Although a manufacturer of a wireless chipset can calibrate the chipset itself, the final product may still suffer from DC offset because the impedance of the antenna is different for each product. In addition, DC offset can also be affected whenever there is saturation caused by interferences or when there is interference at very low frequency offsets from LO frequencies.

Examples of factors that affect DC offset measurements include the non-linear effect of high power jammers, carrier leakage or subcarrier close to receiver local oscillator (LO) frequency, leakage power that is smaller than total interference power, leakage phase that is zero-mean random process, transmitter and receiver are asynchronous, and the delay in propagation is random. Depending on the LO leakage power level, all receivers suffer from DC offset caused by self-mixing of the LO with its leakage. Therefore, DC offset in the receive paths varies across the designs as the antenna impedance changes. It is impossible and impractical to predict the impedance in the final products; thus, it is impossible to predict the DC offset in the final products. This uncertainty causes a problem in determining DC offset cancellation.

Nevertheless, the receiver or wireless chipset is typically calibrated before incorporation into the final product. There are two typical calibration methods: the close loop binary search and the open loop calibration. In the conventional, close loop binary search approach, the calibrated DAC values are identified to overcome the uncertainty in DAC step size caused by process, temperature or channel. In the closed loop search, all possible combinations are tried to determine the minimum DC offset. This approach yields more reliable results but is very time consuming as it has to go through many possible values and at least one measurement of DC at each setting.

Open loop solutions require very precise knowledge of DAC step size to achieve reasonably accurate results. The benefit of open loop approaches is the speed, as it is just one time calculation of the compensation value. However, the precise DAC step size has to be measured on some a test setup in the factor, and, therefore, cannot be obtained once the products are off the product line. This requirement of precise measurement also increases the total cost of the products.

Accordingly, an improved calibration technique is needed.

### SUMMARY

The following summary of the invention is included in order to provide a basic understanding of some aspects and features of the invention. This summary is not an extensive overview of the invention and as such it is not intended to particularly identify key or critical elements of the invention or to delineate the scope of the invention. Its sole purpose is to present some concepts of the invention in a simplified form as a prelude to the more detailed description that is presented below.

This new method avoids the problem brought on by uncertainty, while saving time. Embodiments of the invention are directed to a procedure for accurately calibrating the DC Offset in the receiver chain at a speed similar to open loop solutions, but with accuracy similar to close loop solutions, and which can be done in the factory or in the final product in the field. The calibration process begins by determining the step size and then determining the DC offset compensation using the determined step size. Due to the nature of the analog blocks, the DAC step size is different for each and every chip and this also varies with temperature. Calculating the DAC step size for every chip brings accuracy to the calibrations. With this in hand, the calculation for calibrated DAC values is straight forward resulting in significant amount of time reduction. Further, identifying the DAC step size for each individual chip makes it more a robust calibration.

In accordance with an aspect of the invention, a wireless device is disclosed that includes.

In accordance with yet another aspect of the invention, a method is disclosed that includes.

### BRIEF DESCRIPTION OF THE DRAWINGS

The accompanying drawings, which are incorporated into and constitute a part of this specification, illustrate one or more examples of embodiments and, together with the description of example embodiments, serve to explain the principles and implementations of the embodiments.

FIG. 1 is a block diagram of an exemplary wireless communication system.

FIG. 2 is a schematic block diagram illustrating a wireless receiver according to an embodiment of the invention.

FIG. 3 is a schematic block diagram illustrating calibration of the wireless receiver by applying DAC compensation according to an embodiment of the invention.

FIG. 4 is a flow diagram illustrating a method for calibrating a wireless receiver according to one embodiment of the invention.

FIG. 5 is a flow diagram illustrated a detailed method for calibrating a wireless receiver according to one embodiment of the invention.

FIG. 6 is a block diagram of a wireless device in accordance with one embodiment of the invention.

### DETAILED DESCRIPTION

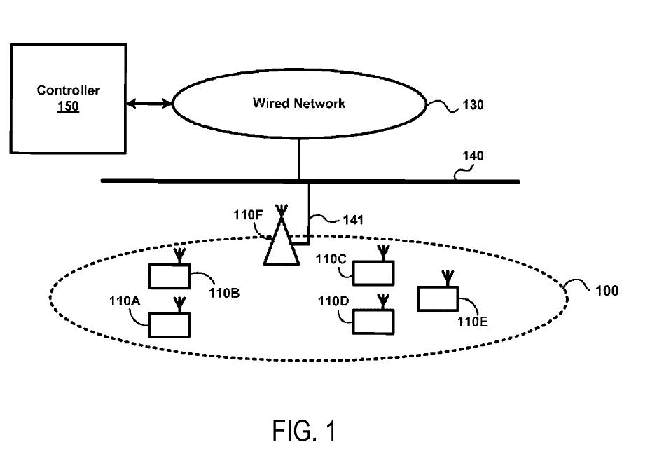

FIG. 1 illustrates an exemplary network including both wired and wireless components. It will be appreciated that the network shown in FIG. 1 and described herein is exemplary and fewer or additional components may be included in the network and other variations may be made to the exemplary network are contemplated. In addition, although certain features of the network are described with reference to a network consistent with the IEEE 802.11 standards; it will be appreciated that the invention may be implemented in networks operating with other wireless network standards, such as, for example, HIPERLAN, IEEE 802.16, Bluetooth, cellular technologies, such as CDMA, WCDMA, LTE, etc., and others, or other non-standards-based wireless networks.

The network 100 illustrated in FIG. 1A includes clients 110A-110E, access point (AP) 110F, wired network 130, wired network backbone 140 and wireless network manager 150. Client 110 represents a basic service set (BSS) consistent with the 802.11 standard; however, as explained above, other wireless implementations are contemplated. The term clients as used herein refers to both end devices (e.g., wireless stations) and an access point.

A wireless local area network (WLAN) generally refers to a wireless network, which facilitates multiple devices to communicate with each other over a wireless medium, and typically includes both wireless stations and an access point. Wireless stations refer to end devices, which transmit and receive packets for communication with other wireless stations and/or other devices within or external to the WLAN. Access points typically refer to devices that are typically intended for receiving and transmitting packets to and receiving packets from the wireless stations and devices external to the WLAN. Access points also manage access to the network, controlling which stations may join, authenticating stations and managing security mechanisms. Access points typically forward or switch packets, send periodic beacons and in general communicate using packet formats designed for operation as an access point.

Access point 110F is connected by a wired medium 141 to wired network backbone 140, which is connected to wired network 130. Each of the clients 110A-110E may communicate with access point 110F as well as with one another wirelessly. The client devices 110A-110E communicate with the wired network 130 through the access point 110F. The wired network 130 may represent the Internet or World Wide Web. The clients 110A-110E may be, for example, a laptop computer, smart phone, wireless sensor, or the like.

Wireless network manager 150 transmits configuration and control messages to the access point 110F. Configuration and control messages that are addressed to the clients 110A-110E are forwarded by the access point 110F to the intended client device recipient 110A-110E by sending either a unicast or a broadcast message. Although the wireless network manager 150 is shown as a separate component from the access point 110F in FIG. 1A, it will be appreciated that the functionality of the wireless network manager 150 may be integrated within the access point 110F.

Wireless network manager 150 may additionally be designed to operate as a controller of BSS 110 and issue network commands to and receive data from one or more of the client devices 110A-110E, and may thus operate to provide certain desired features, such as, for example, building or plant automation, monitoring medical patients, remotely controlling a content storage device, etc. depending on the environment in which the network is deployed. The data received from the client devices 110A-110E may represent measured values of desired parameters, such as, for example, temperature, pressure, humidity, etc. in the case of building automation, measured medical data (e.g., heartbeat, blood pressure, blood glucose, temperature, etc.) about the patient in the case of medical monitoring, video or other data type content in the case of remote control of a content storage device. For example, the access point 110F may be a remote control that controls a client device 110A, and the client device 110A may be a GoPro video recorder. In another example, the client device 110A may be a human wearable tag for collecting blood pressure and the access point 110F may be a mobile phone for communicating the collected blood pressure data to a remote server accessible by a health care professional. It will be appreciated that embodiments of the invention may be implemented in numerous other scenarios.

One or more of client devices 110A-110E may be designed to operate in a “power-save” mode. For example, in the context of IEEE 802.11 standards operation, a client device (e.g., client device 110A) may operate in the standard Power Save Poll Mode (PSPM, or power-save mode, in general). Upon joining BSS 110, the client device 110A periodically “wakes up”, i.e., powers-ON for full functionality from a low power state, to transmit data to or receive data from the access point 110F or other client devices 110B-110E.

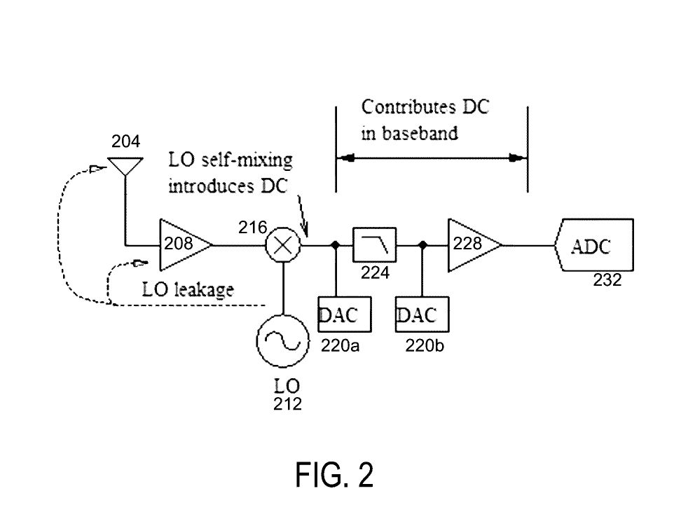

FIG. 2 illustrates a radio frequency (RF) front end 200 of a typical wireless device 200, such as client devices 110A-110E. The front end 200 includes an antenna 204, a low noise amplifier (LNA) 208, a local oscillator (LO) 212, a mixer 216, digital to analog converters (DAC) 220a, 220b, a filter 224, an intermediate frequency (IF) amplifier 228, and an analog to digital baseband converter (ADC) 232. As shown in FIG. 2, the DACs 220, the filter 224 and the IF amplifier 228 contribute DC in the baseband. Furthermore, the leakage and self-mixing from the LO 212 introduce DC into the circuit, which are both undesirable.

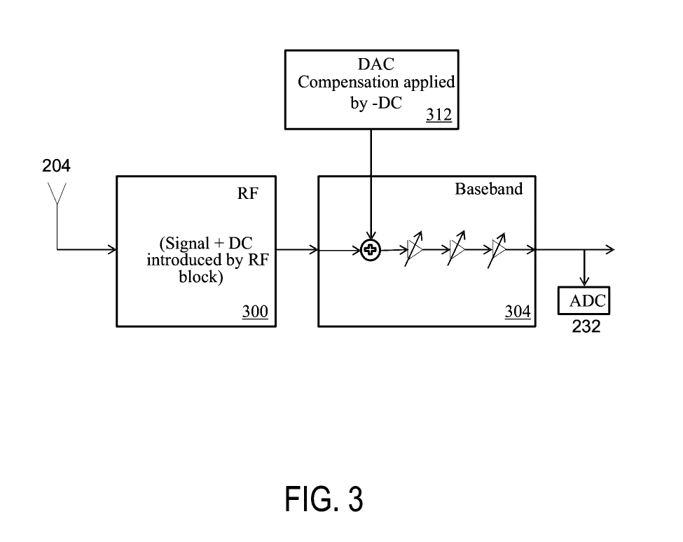

Embodiments of the invention are directed to procedures for accurately calibrating the DC Offset in the receiver chain of a wireless chip or device with the speed of open-loop solutions, but with accuracy of close loop-solutions. FIG. 3 illustrates the application of the DAC compensation to the wireless device for calibrating the DC offset of the receiver chain. As shown in FIG. 3, the signal is received at antenna 204 and continues to the RF block 300. At the RF block 300, the DC offset is typically introduced into the signal. The signal then passes to the baseband 304 and the ADC 308. The DAC compensation 312 is applied to the baseband portion of the receiver 304 at combiner 316.

The calibration process of the invention is used to calculate the DAC compensation 312 applied to the baseband portion of the receiver 304. The calibration process begins by identifying the step size of DC compensation DACs (i.e., how much does the ADC change for each DAC step). The DC offset change between two different DAC values which are 4 steps apart is read. The difference in DC offset is divided by 4 (i.e., the number of steps apart) to obtain the step size of the DAC. This measurement accommodates for variations due to process, temperature and supply voltage. The procedure continues by using the measured step size to compute an optimal compensation value and applying it to the DAC.

The measurement of the step size of a DAC may be independent of the calibration—these can individually be done at any stage. For example, the step size calculation can be performed during the automated test equipment (ATE) phase and the calibrations (e.g., calculation of the compensation based on the step size) can be done during run-time in the firmware or during factory calibrations.

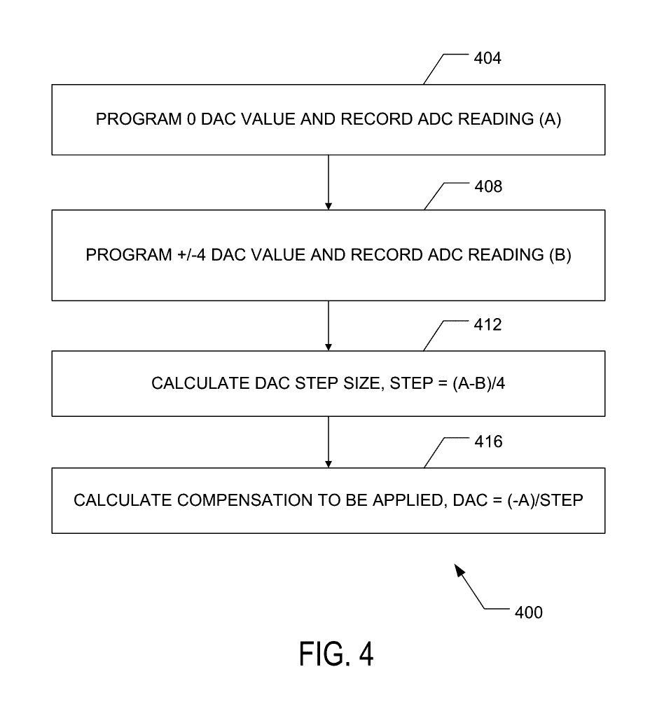

An example of the procedure will not be described with reference to FIG. 4. In one embodiment, the calibration procedure is performed by the firmware of the wireless chipset. It will be appreciated that in alternative embodiments, the process may be performed by another processor on the wireless device, by an external computer, by the hardware (at the RTL level).

The process 400 begins by applying a 0 DAC value at the baseband, and reading the ADC value at the end of the receiver chain (block 404). For example, the ADC value at the end of the receiver chain may be +200 my for a 0 DAC value.

The process 400 continues by applying a −4 DAC value at the baseband, and reading the ADC value at the end of the receiver chain (block 408). In the example, the ADC at the end of the receiver chain may be +40 my.

The process 400 continues by calculating the step size based on the above two readings, Step=(ADC(at DAC=0)−ADC(at DAC=−4))/4 (block 412). In the example, the step size is (200−40)/4=160/4=40 mv. This means, for each step in DAC (+/−1) in the example, the ADC moves by +/−40 mv.

The process 400 continues by calculating the DAC compensation that needs to be applied to the device, Compensated DAC=−(ADC(at DAC=0))/step (block 416). In the example, DAC=−(200)/40=−5. It will be appreciated that calculating the DAC compensation does not need to be done at same time as the steps for determining the step size. This means, if a −5 DAC value is applied at the baseband stage, the ADC reading at the end of the receiver chain is 0 mv. A 0 mv value at the ADC means that no error has been introduced by the analog components in the receiver chain.

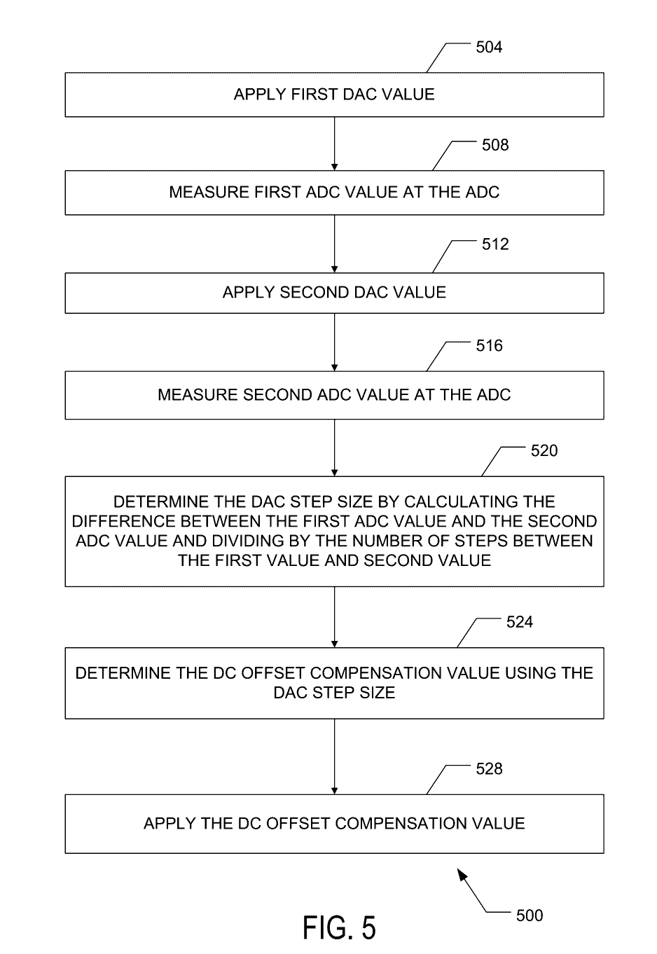

FIG. 4 provided a specific example of a process for calibrating a device. FIG. 5 illustrates a more general description of the calibration process 500. It will be appreciated that the process may be performed on a specific chipset or wireless device, and may be performed in the factory or in the field.

The process 500 begins by applying a first value to the DAC (block 504). For example, the value may be applied to DAC 220a or DAC 220b. In one embodiment, the first value is 0; however, it will be appreciated that any value or range of values may be used for the first value.

The process 500 continues by measuring the value at the ADC at the first DAC value (block 508). For example, the value at the ADC 232 is measured.

The process 500 continues by applying a second value to the DAC (block 512). The second value is separated from the first value by a number of steps. In one embodiment, the number of steps is 4, and may be positive 4 or negative 4. It will be appreciated that the second value may be any value or range of values between four and 500, and may be positive or negative (e.g., between −500 and −4 and between 4 and 500).

The process 500 continues by measuring the value at the ADC at the second DAC value (block 516).

The process 500 continues by determining the DAC step size by calculating the difference between the first ADC value and the second ADC value and dividing the difference by the number of steps (block 520).

The process 500 continues by determining the DC offset compensation for the device based on the DAC step size (block 524). In one embodiment, the DC offset compensation is determined by dividing the ADC value at a DAC value of 0 by the step size determined at block 520.

The process 500 continues by applying the DC offset compensation at the DAC.

It will be appreciated that the initial ADC readings for 0 DAC values should not be above the threshold (i.e., more than 500 mv). For example, an ADC reading of 511 or −512 mv is above the threshold of the ADC. If this happens, then the calculation for step size of DAC values will be thrown off and should be discarded.

The calibration process of the invention can be performed in 200 ms, which is significantly faster than the closed loop approach, which typically takes 10-20s. Additionally, the calibration process of the invention is advantageous because it can be performed on the final product. Further, the calibration can be performed at multiple temperatures to determine the DC offset calibration at different temperatures. Similarly, the calibration process can be performed for various enclosures, which can impact the DC offset of the device.

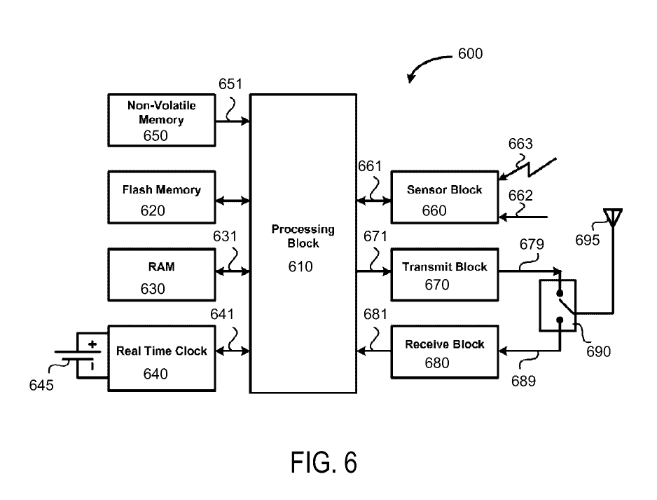

FIG. 6 illustrates exemplary components of a wireless device 600. The wireless device 600 corresponds to the wireless station or client device 110A-110E shown in FIG. 1 and described herein. It will be appreciated that the access point 110F typically includes the similar components to those shown in FIG. 6; however, the access point 110F may include fewer components than shown in the wireless device of FIG. 6 and may also include additional components than those shown in FIG. 6, and that the arrangement of the components may differ.

Exemplary implementations of wireless device 600 are disclosed in U.S. Pat. No. 7,941,682, entitled “Optimum Power Management of System on Chip Based on Tiered States of Operation”, issued May 10, 2011, and U.S. Patent Publication Nos. 2009/0016251, entitled “Management System and Method of Low Power Consuming Devices, filed Jul. 13, 2007, 2009/0077404, entitled “Method and System for Reducing Power Consumption of System on Chip Based Analog-to-Digital Control Circuitry,” filed Sep. 14, 2007, each of which is assigned to Gainspan, Inc., the entireties of each of which are hereby incorporated by reference. It will be appreciated that other implementations of the wireless device 600 are contemplated and such wireless device 600 should not be limited to the disclosures incorporated by reference or the exemplary wireless device illustrated in FIG. 6.

Wireless device 600 includes a data processing system 610, flash memory 620, random access (RAM) memory 630 a real-time clock (RTC) 640, power supply 645, non-volatile memory 650, sensor(s) 660, a transmitter 670, a receiver 680, switch 690 and antenna 695. It will be appreciated that the wireless device 600 may be implemented as a system-on-chip (SoC) or as separate integrated circuits (IC) or combinations thereof. Additionally, it will be appreciated that the wireless device 600 may have fewer or greater components than those shown in FIG. 6 and that the arrangement of the components shown in FIG. 6 may differ.

Data processing system 610 is a processor that may contain one or more processing units. In embodiments in which the data processing system 600 includes multiple processing units, each processing unit may be designed for a specific task. Alternatively, the data processing system 610 may contain a general purpose processing unit. In yet another embodiment, the data process system 610 may contain multiple general purpose processing units that share processing for all tasks in a mutual way.

Flash memory 620 contains memory locations organized as blocks. A block represents a set of memory locations (typically continuous in terms of memory address) which are to be all erased before data can be rewritten into any location. Flash memory 620 may be used to store data from sensor(s) 660 via data processing system 610 and/or store program code.

RAM 630 and non-volatile memory 650 (which may be implemented in the form of read-only memory (ROM)) constitute computer program products or machine readable medium which provide instructions to data processing system 610. RAM 630 communicates with data processing system via path 631. The non-volatile memory 650 may include sub-components (not shown), such as OTP and EEPROM.

RTC 640 operates as a clock and provides the current time to data processing system 610 on path 641. RTC 640 may be backed-up by power supply 645. RTC 640 may also contain memory to store critical information received from the data processing system 610.

Non-volatile memory 650 is a non-transitory computer readable medium that stores instructions, which when executed by the data processing system 610, cause the wireless device 600 to process the data and messages received from the receiver and generate the data and messages for transmission by the transmitter. The non-volatile memory communicates with data process system 610 via path 651.

Sensor(s) 660 may include one or more sensors as well as corresponding signal conditioning circuitry. As an alternative, sensor(s) may instead be any data capture device, such as a video recording device or other data collection or capture devices. Sensed parameters or data are transmitted on path 661 via a wired path 662 or wireless path 663.

Transmitter 670 receives data to be transmitted from data processing system 610 on path 671. Further, the transmitter 670 generates a modulated radio frequency (RF) signal according to IEEE 802.11 standards and transmits the RF signal via switch 690 and antenna 695.

Receiver 680 receives an RF signal bearing data via switch 690 and antenna 695. The receiver 680 further demodulates the RF signal and provides extracted data to the data processing system 610 on path 681.

Antenna 695 operates to receive from and transmit to a wireless medium wireless signals containing data and messages. Switch 690 may be controlled by the data processing system 610 to connect antenna 695 to the receiver 680 via path 689 or transmitter via path 679 depending on whether the wireless station is receiving or transmitting.

One or more of the methodologies or functions described herein may be embodied in a computer-readable medium on which is stored one or more sets of instructions (e.g., software). The software may reside, completely or at least partially, within memory, as described above, and/or within the data processing system during execution thereof. The software may further be transmitted or received over a network.

The term “computer-readable medium” should be taken to include a single medium or multiple media that store the one or more sets of instructions. The term “computer-readable medium” shall also be taken to include any medium that is capable of storing, encoding or carrying a set of instructions for execution by a machine and that cause a machine to perform any one or more of the methodologies of the invention. The term “computer-readable medium” shall accordingly be taken to include, but not be limited to, solid-state memories, and optical and magnetic media.

Embodiments of the invention have been described through processes or flow diagrams at times, which are defined by executable instructions recorded on computer readable media which cause a computer, microprocessors or chipsets to perform method steps when executed. The process steps have been segregated for the sake of clarity. However, it should be understood that the steps need not correspond to discreet blocks of code and the described steps can be carried out by the execution of various code portions stored on various media and executed at various times.

It should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The invention has been described in relation to particular examples, which are intended in all respects to be illustrative rather than restrictive. Those skilled in the art will appreciate that many different combinations of hardware, software, and firmware will be suitable for practicing the present invention.

The present invention has been described in relation to particular examples, which are intended in all respects to be illustrative rather than restrictive. Those skilled in the art will appreciate that many different combinations will be suitable for practicing the present invention. Moreover, other implementations of the invention will be apparent to those skilled in the art from consideration of the specification and practice of the invention disclosed herein. Various aspects and/or components of the described embodiments may be used singly or in any combination. It is intended that the specification and examples be considered as exemplary only, with a true scope and spirit of the invention being indicated by the following claims.

What is claimed is:

1. A wireless device comprising:
a receiver to receive a receive signal from one or more other wireless devices;
an antenna coupled to the receiver;
a processor configured to determine a DC offset compensation of the wireless device based on a calculation of step size of the wireless device and apply the DC offset compensation to the wireless device; and
memory to store the step size and DC offset compensation.

2. The wireless device of claim 1, wherein the step size is calculated by determining the DC offset between two values which are four steps apart and dividing the DC offset by four.

3. The wireless device of claim 1, wherein the receiver comprises an RF block and baseband, and wherein the DC offset compensation is applied to the baseband.

4. The wireless device of claim 1, wherein the receiver further comprises an analog to digital converter (ADC) and a digital to analog converter (DAC).

5. The wireless device of claim 1, wherein the DC offset compensation is determined by dividing the negative value at the ADC when the DAC is at 0 by the step size.

6. A method comprising:
applying a first DAC value at the baseband of a wireless device;
measuring a first ADC value at the ADC of the wireless device;
applying a second DAC value at the baseband of a wireless device, wherein the second DAC value differs from the first DAC value by a plurality of steps;
measuring a second ADC value at the ADC of the wireless device;
determining a DAC step size, wherein determining the DAC step size comprises calculating the difference between the first ADC value and the second ADC value, and dividing the difference by the plurality of steps;
determining a DC offset compensation value for the wireless device based on the DAC step size; and
applying the DC offset compensation value at the DAC of the wireless device.

7. The method of claim 6, wherein the plurality of steps comprises +4.

8. The method of claim 6, wherein the plurality of steps comprises −4.

9. The method of claim 6, wherein the DAC value is a value between −500 mV and 500 mV.

10. The method of claim 6, wherein the first DAC value is 0.

11. The method of claim 6, wherein when the DC offset compensation value is applied to the DAC, the value at the ADC is 0.

12. The method of claim 10, wherein the second DAC value is −4, and wherein the plurality of steps is 4.

13. The method of claim 6, wherein the determining the DAC compensation comprises dividing the first ADC value by the determined DAC step size.

14. A method comprising:
determining a DC offset compensation of a specific wireless device based on a step size of the specific wireless device; and
applying the DC offset compensation to the specific wireless device.

15. The method of claim 14, wherein the DC offset compensation is applied to baseband of the specific wireless device.

16. The method of claim 14, wherein the step size is calculated by determining the DC offset between two values which are four steps apart and dividing the DC offset by four.

17. The method of claim 16, wherein the step size is calculated by measuring a first ADC value at a DAC value of 0, measuring a second ADC value at a DAC value of +/−4 steps, and dividing the difference between the first ADC value and the second ADC value by four.

18. The method of claim 14, wherein the step size is calculated by measuring a first ADC value at a first DAC value, measuring a second ADC value at a second DAC value separated by a number of steps, and dividing the difference between the first ADC value and the second ADC value by the number of steps.

19. The method of claim 14, wherein the number of steps is at least four steps.

20. The method of claim 14, wherein the DC offset compensation is determined by dividing the negative value at the ADC when the DAC is at 0 by the step size.
